(19) United States
(12) Patent Application Publication
(10) Pub. No.: US 2010/0023871 A1
(43) Pub. Date: Jan. 28, 2010

(54) Methods and Systems Providing an Interactive Social Ticker

(75) Inventors: Benjamin B. Bederson, Chevy Chase, MD (US); John SanGiovanni, Seattle, WA (US); Stephen E. Dossick, Seattle, WA (US)

Correspondence Address: FULBRIGHT & JAWORSKI L.L.P, 2200 ROSS AVENUE, SUITE 2800, DALLAS, TX, 75201-2784, US

(73) Assignee: ZUMOBI, INC., Seattle, WA (US)

(21) Appl. No.: 12/180,485

(22) Filed: Jul. 25, 2008

(51) Int. Cl. G06F 3/00

(52) U.S. Cl. 715/745; 715/733; 715/744

(57) ABSTRACT

A user interface for use in one or more processor-based devices comprising an interactive, social ticker shared among a plurality of users, the interactive social ticker including an animated flow of selectable content.

### TECHNICAL FIELD

The present description is related, in general, to user interfaces and, more specifically, to user interfaces with informational flows.

### BACKGROUND OF THE INVENTION

Discovery of information content is currently done in a variety of ways. The most basic form involves sitting at a computer, or watching TV, or using a mobile phone, and receiving sequential screenfuls of information. Other such occurrences of sequential screenfuls of information include rotating billboards and public electronic displays. In the case of traditional television news programs, there is a method for feeding the stream of stories that are presented. Usually a producer in the background carefully queues up a collection of late-breaking things but also has a collection of human interest stories of less timely things that can be put in as filler. The producer will insert a human interest story so that viewers perceive a “flow” to the program.

Another technique includes news tickers, such as in Times Square, where information zips along a building, a screen of a computer, or television tickers found on cable news networks. Yet another technique is an email-style interface which is used by Really Simple Syndication (RSS) readers that have a list of top level objects, categorical headings, and when a top-level object is selected, it expands and shows the actual content of a post and additional information. The above-listed techniques are transitive and not participatory—they just give a user information, and the information is not typically specific to a user. Instead, the information is typically a public feed of information.

There are currently available interactive tickers and RSS feeds. For example, POINTCAST™ is a program that feeds information across a computer screen. Also, there is an RSS screen saver that is part of the MACINTOSH™ operating system that sends RSS feeds across a screen in a graphically animated way. Such tickers are only interactive in the sense that a user can speed them up or slow them down. There is not much interaction with the content in the stream itself.

A more advanced technique includes social content discovery. In such systems, a social group decides on content that a user might be interested in. An example is the popular website Digg.com that provides collaborative recommendation. Another approach is collaborative filtering, which is based on the assumption that a community of like-minded people can give a user advice on what the user might want to see. Another example of use of a collaborative filter is with Amazon.com, wherein a user's purchase is compared to the purchases of other users who purchased the same thing. Amazon.com provides advice, such as “other people who bought razors also bought shaving cream.” There is a variation on collaborative filtering, which includes the idea that not only can individual items of information be rated, but that the raters themselves develop reputations and their recommendations are weighted by their reputations. One site in particular, called Slashdot.org is well known for letting the highly reputed people have more influence and the way that someone gets a higher reputation is by using the site for a longer period. The first few months a user of Slashdot.org has a low reputation, but if the user has been rating for some time and people have commented positively on the user's recommendations, then the user's reputation goes up. Variations of collaborative filtering can get fairly complex.

In the case of Digg.com, there is a community of people who provide suggestions for information content. However, the Digg.com community is like an island, and there are other island-like collaborative communities on the Internet. There is some desire to be able to aggregate the suggestions or content from a number of such islands. To fill that desire, there are a few aggregator sites as well that, for example, display the results of the social recommendations of ten other sites.

Yet another information discovery technique is pseudorandom presentation. An example of pseudorandom presentation is Stumbleupon.com, which gives a user a button to click, and it takes the user to a random web page. It is pseudorandom, rather than random, in that it is subsetted by some general characteristics, such as user interest and collaborative filtering.

A variation on social content discovery is provided by Twitter.com and Plurk.com. Both web services allow users to post very short messages. Twitter.com entries look like entries in a blog, whereas Plurk.com entries are posted to a timeline-type background to show the movement of time.

While many of the sites mentioned above are convenient for use on computer desktops, they typically have too much content to be able to be used easily on mobile processor-based devices, such as phones and Personal Digital Assistants (PDAs) (although some of the sites mentioned above do provide versions usable from a mobile phone). The user experiences built on the above-described techniques are typically not as good on mobile devices due to unique requirements of mobile devices: 1) the screens are small and do not have the ability to show as much information at a time, and 2) the traditional way that people use mobile devices is different than on a desktop computer. With mobile devices, people are much more likely to pull out a phone, do something for fifteen or thirty seconds and move on to something else. Thus, applications for mobile devices usually have a very short targeting interaction that gives the user something of value. Another limitation of mobile devices is that not only is the screen smaller, but the input mechanisms are of lower quality so that it is harder to input information. Currently, there is no technique for providing information discovery that is capable of providing content to mobile devices (as well as to desktop devices) while being rich enough to be useful while still being elegant.

### BRIEF SUMMARY OF THE INVENTION

Various embodiments of the present invention are directed to user interfaces that include a plurality of information flows. Each of the information flows, in some embodiments, appears as a river of information items (widgets, icons, etc.), and information items can be moved among the various information flows.

Some embodiments include an interactive ticker where a user can select, open, move, delete, and/or take other actions with respect to the information items. In another aspect, some embodiments provide an interactive social ticker so that users can see content selected by others in their social group and also send information items to others. The social ticker acts as a conversational mechanism among users. In yet another example, some embodiments include an interactive social targeted ticker in the sense that, based on how a user interacts with the ticker, informational items appearing in the ticker can be selected based upon past use and interests.

In one example, a first information flow contains items from public sources, such as news feeds. The feed of information in the first flow can be provided by, e.g., a network provider or a provider of the user interface program. In some embodiments, the items in the first information flow are general interest and supplemented with advertisements. A second information flow includes items that are socially filtered and shared among a plurality of users. In the second flow, the user sees information items that have been chosen by other people in his social group. The user can also select and/or create information items for insertion into the second information flow, thereby providing those information items to other people in his social group.

A third information flow includes items that are sent to the user based on user preferences. In one embodiment, when a user moves an item from the first information flow to the social flow, such action indicates user interest. The information is saved and used (e.g., by the network provider or UI provider) to select items to feed into the third information flow. Additionally or alternatively, a user profile set up and modified by a user can be used to populate the third flow with information items.

As mentioned above, informational items can be moved among the flows. For example, if a user sees a headline for a news article in the public flow, the user can “grab” the headline and place in the personal flow for reading at a later time and/or to indicate a preference. Additionally, the user can place the headline in the social flow if he wants his friends to see the story as well.

In another embodiment, the interface includes a combined flow with public, personal, and social items together. In such an embodiment, a user can express personal interest in an item by opening it or otherwise marking it as interesting. Furthermore, the user can send the item to his social group by commenting on it, putting the item in a message, selecting a function option that sends it to a social group, and or the like. Other ways of showing interest in an item or sending it to a social group are possible and within the scope of embodiments.

Another aspect of some embodiments of the invention includes the interaction of a device (e.g., a mobile device, a desktop computer, and/or the like) with one or more servers. In one example, a mobile device is in communication with a cellular telephone network. At least one server is also in communication with the cellular network. In some examples, the server is associated with the network provider or with the provider of the user interface. From time to time, the mobile device polls the server to request information. In response to the poll, the server may or may not provide headline information (or in some cases, an entire item) for either of the public or personal information flows. If there is a social message waiting for the user of the mobile device, the server will provide the message in response to the poll.

When a user inserts an item into the social information flow or otherwise sends an item to his social group, the mobile device sends a message to the social server, using standard network-based communication mechanisms. In some examples, the social server saves information indicating which users are affiliated with which social groups. In some embodiments, the messages sent from each mobile device indicate to which other users the message should be delivered. In either case, the social server sends the message when it is polled by an intended recipient.

In example embodiments, the display of the information flows includes an animated flowing motion so that the information items appear to move from one side of the screen to the other and to disappear/reappear at the sides of the screen. The animated flow allows for a screen to continually display more information items that it would be able to if the user interface was a list. Further, the animated flow provides for an intuitive interface, where users understand that an item that previously crossed the screen and disappeared will eventually appear again and “float” across the screen. Bobbing motions and swerving (as might happen due to waves or other disturbances) may be added to simulate floating on top of water. Water-like motion can often be soothing to human users.

The systems and methods according to the above-described techniques can offer social mobile content discovery by offering a user experience toward public information that is available both through publicly edited feeds of information, social recommendation, and personal selection. Such embodiments may also offer a balance between hands-free browsing and highly controlled access and search of specific information items. In addition, some embodiments can be integrated with business models such as advertising and targeted content through, e.g., business deals and subscription models.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIGS. 1A-D are an illustration of an exemplary User Interface (UI) according to one embodiment of the invention;

FIG. 2 is an illustration of a traditional directional keypad;

FIG. 3 is an illustration of an exemplary system adapted according to one embodiment of the invention;

FIGS. 4-7 are illustrations of exemplary methods adapted according to various embodiments of the invention;

FIGS. 8-10 are illustrations of exemplary methods of interaction between devices, applications, users, and content servers, according to various embodiments of the invention; and

FIG. 11 illustrates an example computer system adapted according to one embodiment of the present invention.

### DETAILED DESCRIPTION OF THE INVENTION

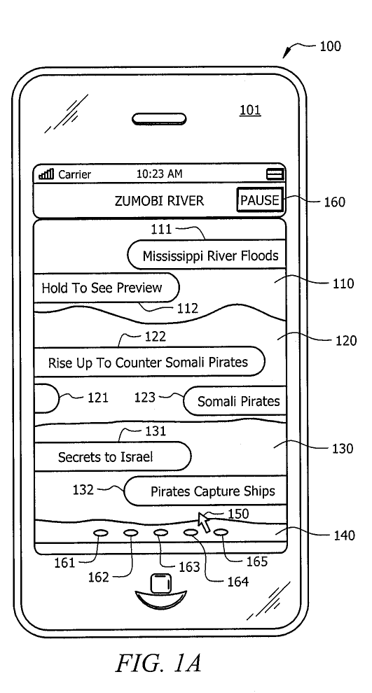

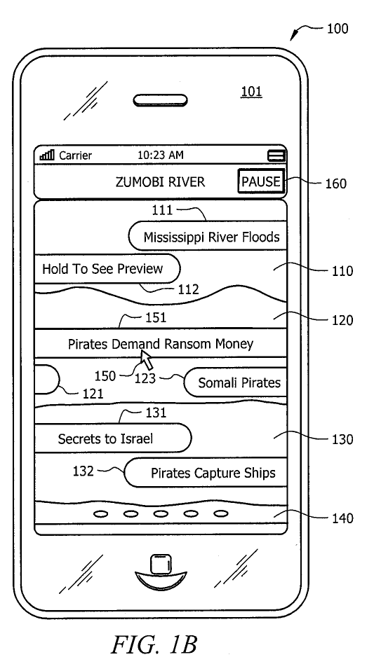

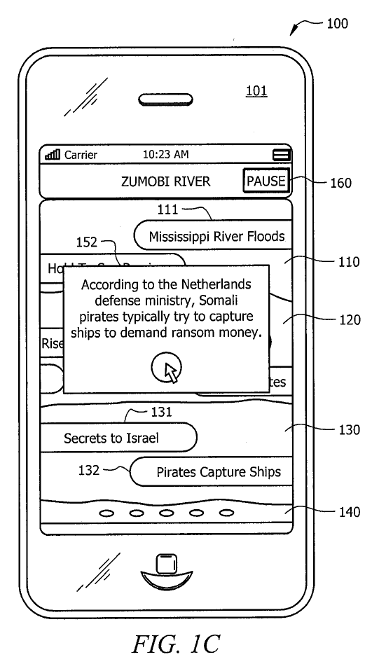

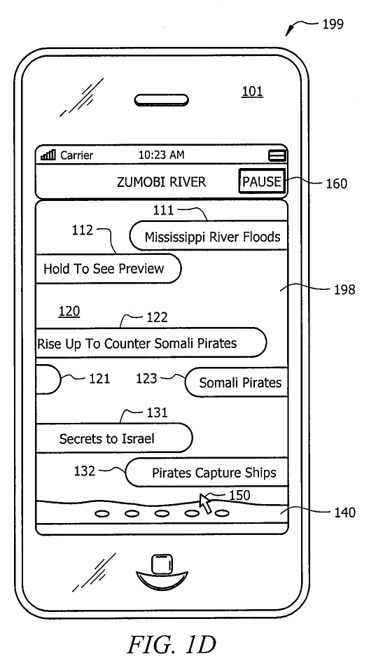

FIGS. 1A-C are illustrations of exemplary UT 100 adapted according to one embodiment of the invention. UI 100 in this example includes computer executable code stored to a tangible computer-readable medium (e.g., a hard drive, flash memory, ROM, RAM, etc.) and executed by processor-based device 101. While processor-based device 101 is shown as a IPHONE™ mobile device, the scope of embodiments is not so limited, as other processor-based devices, such as laptop/desktop computers, Personal Digital Assistants (PDAs), and the like may be used as well.

UI 100 includes three information flows 110, 120, and 130 (collectively referred to herein as “the river”). The information content is displayed in this view by symbolic items 111 and 112—in this case, headlines, as opposed to the full news stories. Information items for any of the flows 110, 120, 130 can include any of a variety of symbolic items (icons, widgets, tiles, etc.) that represent selectable content and/or the content itself (e.g., pictures, text messages, news stories, etc.). UI 100 also includes cursor 150 and “beach” area 140.

Each of flows 110, 120, and 130 are interactive. That is, a user can select information content from each of flows 110, 120, and 130 and perform actions on the information content. In one example, the user selects a headline to view a full story or a snippet of a story. In FIG. 1B, the user has moved cursor 150 (by e.g., touching and/or tapping the screen of the mobile device) over headline 122. UI 100 provides color indicator 151 to inform the user that item 122 can be selected with the cursor at its current position. The user then selects item 122 (by, e.g., tapping the screen or a button). UI 100 then provides the underlying information content in window 152, as shown in FIG. 1C.

The plurality of information flows provided by UI 100 builds a rich, interactive experience for a user. In one example, each of flows 110, 120, and 130 provides different functionality. For instance, information flow 110 is a public flow that receives general interest content (including advertisements) from one or more sources, and the content includes news, RSS feeds, advertisements, and the like. An example of general interest content is weather news and top news headlines. Information flow 110 can be presented by any of a variety of entities, such as the user's network provider, the provider of UI 100, and others. In fact, in some embodiments, information flow 110 displays the same items for all users of UI 100 and presents advertisements therein to generate revenue.

Information flow 120 is a social flow, where the content therein is selected and shared by a number of users, including users of other mobile devices. From a given user's perspective, the social group is a collection of people whom the user has identified as his friends. Information flow 130 is a personal flow where the items (including advertisements) are filtered for user interest. Information flow 130 can be populated by any of a number of entities, such as the network provider and/or the provider of UI 100.

Continuing with the present example, the user can move information items (e.g., 111, 112, 121-123, 131, and 132) among the flows 110, 120, and 130. Should the user see a basketball score (not shown) in a headline in flow 110, the user can choose to share the score with his social network by placing the headline in flow 120. A dragging motion is one example of a technique that can be used to move items between the flows with touch screen devices and mouse-equipped devices. For keypad-based devices, moving items can be accomplished, e.g., with various key combinations.

When moving an item, such a sports headline, to a social flow (e.g., flow 130), many embodiments allow a user to type out a message (e.g., a text message) for inclusion with the item. Thus, a user can pass along a sports score as well as gloat to his friends. Since users can create and share their own content, flow 120 has a conversational quality. The user can also take an item of information from flows 110 and/or 120 and place them in information flow 130 to indicate user interest.

Embodiments of the invention provide for control of UI 100 through a number of techniques. In the examples of FIGS. 1A-C, beach 140 provides controls in the form of “pebbles” 161-165, which are buttons made to look like rocks on the shore. As explained below, various embodiments give the user some amount of control of the motion of information flows 110, 120 and 130. Such control can be exercised through the use of pebbles 161-165. Other examples of control functions include a general settings pebble that lets a user configure which content the user wants and who the user's friends are. Some embodiments use pebbles for special content control, e.g., a photo service pebble, that allows a user to log into a photo service and place his personal photos in one of the information flows 110, 120, and 130. Other examples of special content pebbles include a social networking pebble that allows the user to get content from a social networking site and a search engine pebble that opens up into a search interface (e.g., a text box and a button) where results are returned into one or more of flows 110, 120, and 130. The idea is that UI 100 has controls that let users configure the content that goes in information flows 110, 120, and 130.

As mentioned above, users can create new content within the river and send it to their friends in their social group. Any one of pebbles 161-165 can be used to cue an SMS or MMS message interface that allows the user to create a message and to release the message to the river (in such a case, the message would most likely go in social flow 120). In fact, pebbles 161-165 can be used to enable a user to create any kind of content that device 101 is capable of receiving or recording. If device 101 has a camera, for instance, a user can take a picture and deposit it into the river using a pebble. If device 101 has a microphone, the user can record a message and deposit the message into the river using a pebble. If device 101 has a drawing program, the user can draw a picture of an avatar and deposit the avatar into the river using a pebble.

As mentioned above, UI 100 provides ways for users to manipulate the motion of flows 110, 120, and 130. On a touch-screen or pointer-based device, a user can speed up or slow down the river by dragging left and right or using pause button 160. Some users may prefer no constant flowing movement, and embodiments of the invention can accommodate such preferences. For instance, some embodiments provide next and previous buttons (not shown), so rather than having a flow, UI 100 shows six items at a time, and when the user presses next, UI 100 shows the next six items, and then the next six or the previous six. In such embodiments, the movement is under user control. Additionally or alternatively, such control may be provided via one or more of pebbles 161-165.

Moreover, some embodiments provide for minimizing information flows. In one example, a user prefers to receive only his friends' socially-filtered content. The user can specify that information flows 110 and 130 are to be minimized. Later, the user can expand flows 110 and 130 so that they are displayed once again on the screen.

FIG. 1D is an illustration of exemplary user interface 199, adapted according to one embodiment of the invention. User interface 199 employs a single, combined flow 198, as opposed to a multiplicity of flows in the embodiments described above. Combined flow 198 includes public content (as in flow 110 of FIG. 1A), content shared among a social group (as in flow 120 of FIG. 1A), and personal interest content (as in flow 130 of FIG. 1A). When a user desires to express personal interest in an item, the user can open the item, mark the item, select a function option (e.g., a button), and/or the like. Similarly, when a user desires to send an item to a social group, the user can mark the item, select a function option, and/or the like. The features and functions described herein with reference to multiple-flow embodiments can be adapted for use in single-flow embodiments as well. An embodiment with a single, combined flow gives up the ease of being able to move items among flows, but gains an advantage in that is simpler than a multiple flow embodiment, which is preferable to some users. Embodiments of the invention can include any number of flows.

Embodiments of the invention can be used with any of a variety of devices and any of a variety of screen sizes. Whether it is touch-screen or mouse interaction, joystick interaction, or up-down-left-right directional key action, UI 100 shows a flow of items that are coming across the screen at varying rates of speed. The user can interact with the individual objects. In order to make the interaction more intuitive, flows 110, 120, and 130 can be adapted for language and region. Thus, in the Europe and the Americas, where people read left to right, the flow of information is also left to right. In the Middle East, where many people read right to left, the information flow can be adapted to be right to left. Further, the information flow does not have to be horizontal, as it can be vertical as well.

One or more features can be added to some embodiments of the invention to help strike a balance between the user's being in control and the user's having direct access to information. One such feature is the provision of a search button (e.g., a pebble) that allows a user to type in a few characters, and the search function filters the items in the river so that it only shows the items that match that search filter. This enables a user to skip right to an item of interest. For example, a user can type in “weather” or “weat” and get all news about weather.

Another such feature allows a user to filter contents by origin. For example, if a user sees an article from The New York Times and wants to see all of the articles from The New York Times, then the user can use a button (e.g., a pebble, or a button in the New York Times item) specifying that the user desires to filter the contents by feed. The user then sees only the items that are from The New York Times. Such features illustrate the evolution of moving from purely under computer control (where a user gets what is what is fed to him) to a higher level of user control, and UI 100 can integrate such features into a single experience.

As mentioned above, some embodiments of the invention can be implemented on devices that are less sophisticated than the IPHONE™ device. Some embodiments work very well with next generation hardware because next generation hardware has better rendering and more screen space, which allows UI 100 to show more content. Other examples of next generation hardware include Android™ phones, BLACKBERRY™ phones, phones that run WINDOWS MOBILE™, and the like. Current generation hardware can also be used, especially for more scaled-down versions of UI 100 that have less animation and show fewer items, but performs substantially the same core functions.

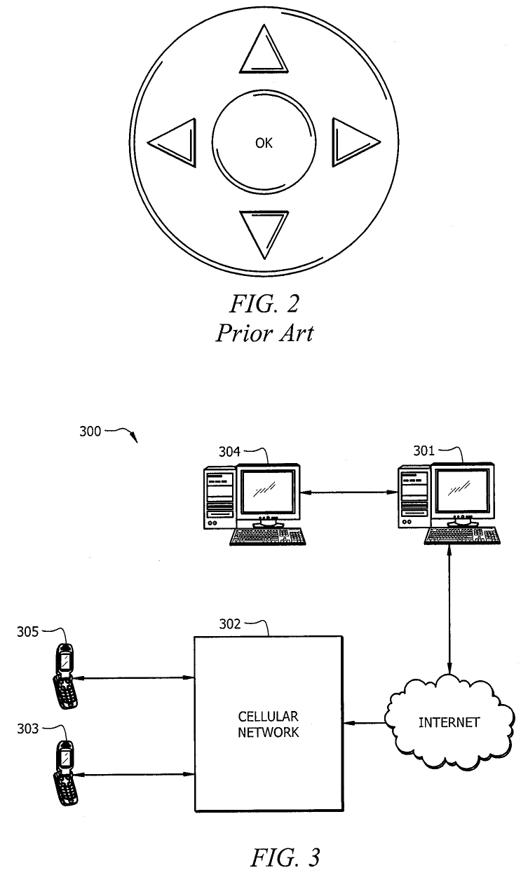

Almost all processor-based devices include a four-way direction pad as well as a dozen or more keys. The interaction shown above can be mapped to a standard four-way directional keypad, such as the exemplary, traditional keypad shown in FIG. 2. For example, consider a visual metaphor with the three information flows 10, 120, and 130, and the up and down controls on a directional keypad navigate from flow to flow and from item to item within a flow. Left and right controls move to the next three or six items that are presented in each flow, so that left and right controls manually actuate the movement of the river. Thus if a user desires to look through data quickly, the user can hold down the right key, and the river flows. If a user desires to stop or pause the river the user can let up on the left/right control. The action button (e.g., an “OK” or “ENTER” button) on the directional keypad can be used to select or open items. Various embodiments use the metaphor described above to create an intuitive mapping of directional keypad controls to functions. Other ways of mapping can be used and are within the scope of embodiments.

While the illustrated embodiment of FIGS. 1A-C focuses on a mobile processor-based device, various embodiments of the invention are not so limited. Interface 100 can be implemented on a laptop computer, a desktop computer, or any kind of processor-based device with a graphical input/output scheme. When implemented on a large screen, such as a standard desktop screen, it is possible for the user to grab items from the desktop and insert them into information flow 120. For example, a user can drag elements from his desktop web browser into UI 100 and have it show up in the social flow so that his friends see it. Moreover, the various embodiments are not limited to cellular applications, as devices on other kinds of networks, such as WiFi, Ethernet, token ring, and the like, can be used as well.

A variety of different information items can be presented in the river. One example of an information item is text items, such as RSS feed titles and headlines. When a user selects a title, the article (or a portion thereof) is presented to the user. Pictures can be presented in the river as well. In one example, a picture is reshaped to fit into the river, and when a user selects the picture, the picture expands to its correct dimensions. Web widgets can also be placed in the river. Some embodiments can accept web content such as a clock, a game, or current weather and any standardly available current web widget and put it in as an item. Widgets represent live web content, and when a widget is selected, it goes to the full web page so that the user sees the full detailed version. In one example, a widget representing an email, text message, MMS message, or other content, is placed in the river. Icons, tiles, and the like make a non-exclusive list of other information that can be inserted into the river.

FIG. 3 is an illustration of system 300 adapted according to one embodiment of the invention. System 300 includes server 301, cellular network 302, mobile devices 303 and 305, and server 304. Mobile devices 303 and 305 are in communication with cellular network 302 for voice and data. Server 301 is used to provide data to mobile devices 303 and 305 and may be affiliated with the cellular network provider or a third party, such as a provider of an interface according to one or more embodiments of the invention. Server 304 provides data content, such as RSS feeds, headlines,

In this example embodiment, server 301 is not capable of talking down to the mobile device 303 because of the way that cellular network 302 operates. Mobile device 303 polls server 301 every so often to request any messages that have been targeted to it (e.g., by being places into a social information flow). When the user of mobile device 303 sends a message to a social group, a connection is made up to server 301, and mobile device 303 sends the message along with an indication of an intended recipient social group. Server 301 then examines the message and determines which social group the message was routed at, as well as which user sent the message. Server 301 then makes a copy of that message for each member of the target social group. When mobile device 305, belonging to another member of the social group, polls server 301, server 301 sends the message to mobile device 305.

It system 300, the polling frequency is configurable. In some embodiments it is no less than every half hour, but it could be anywhere from every ten minutes, every minute, or as often as bandwidth and computing resources allow.

One feature of server 301 is that it is separate from the servers (e.g., server 304) that are providing the data feeds that are in the river. Embodiments layer the social interaction on top of the data feeds that are coming from other providers. In many instances, the social layering does not involve any interaction or any relationship (other than ordinary interactions and relationships) between server 301 and server 304. In other words, the layering that is performed by server 301 is not “known” to server 304.

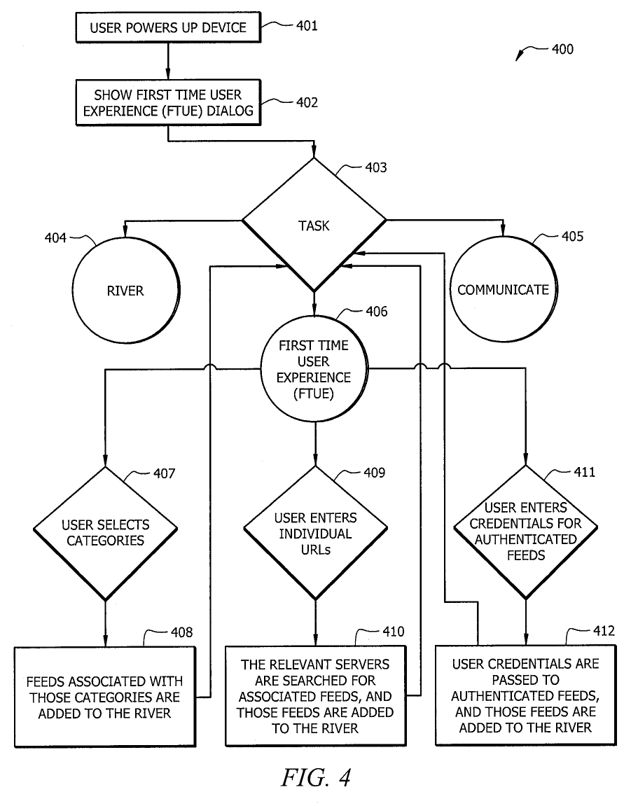

FIGS. 4-10 are illustrations of exemplary methods adapted according to various embodiments of the invention. Method 400 of FIG. 4 shows one example of logic for single-handed navigation of an interaction with feeds, widgets, and social interaction on, e.g., touch-screen mobile devices. Method 400 assumes a first-time user experience. Some of the actions shown in FIG. 4 are performed by a user, some are performed by the device, and others are performed by a server (such as server 301 of FIG. 3).

In action 401, the user powers up the device, and in action 402, the device shows the first time user experience (FTUE) dialog. In action 403, the user can skip the FTUE dialog and go straight to the river interface (as in action 404) or to other communication applications (e.g., phone calls, voice mails, etc., as in action 405) or the user can continue with the FTUE interface to configure his experience in the river interface (as in action 406).

Should the user continue with the FTUE dialog, the user can select categories of information for his personal flow (and in some embodiments, for the public flow as well). In action 407, the user selects categories of interest for the flows, and in action 408, a server adds feeds associated with those categories to the river interface. In action 409, the user selects content by entering Universal Resource Locators (URLs) of content in which the user is interested. In action 410, feeds associated with the URLs are added to the river interface. In action 411, the user enters credentials for authenticated feeds (e.g., feeds requiring logins and passwords), and in action 412, the user credentials are used to access the authenticated content to create one or more feeds for the river interface. Any of the actions of method 400 may be repeated, and some may be skipped.

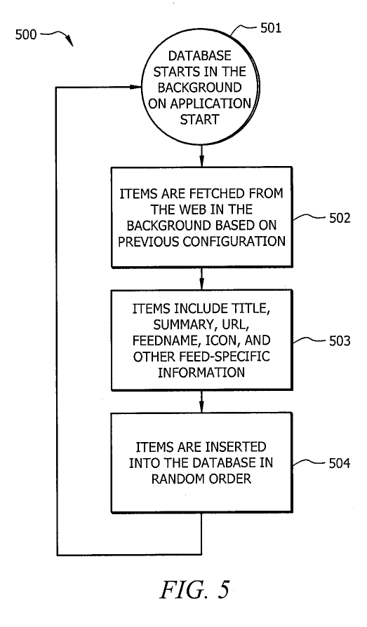

Method 500 of FIG. 5 shows one example of logic for discovering and reading information in the river interface. The actions shown in FIG. 5 are performed by the device, such as a hand-held device. In action 501, the database starts in the background at startup of the interface application (e.g., at device power-up or when the interface application is selected by the user). In action 502, the application uses the user's previously-stored configuration from the database to fetch information items from the Web. Sometimes fetching will occur through a server, such as server 301 of FIG. 3, and sometimes the application fetches the items itself.

In action 503, the items are received. Items can include any of a variety of the following information components: title, summary, URL, feed-name, icon, feed specific information, etc. In action 504, the application inserts the items into the database, sometimes in random order. In some embodiments a random order in the database facilitates the placement of items in the river in the same random order.

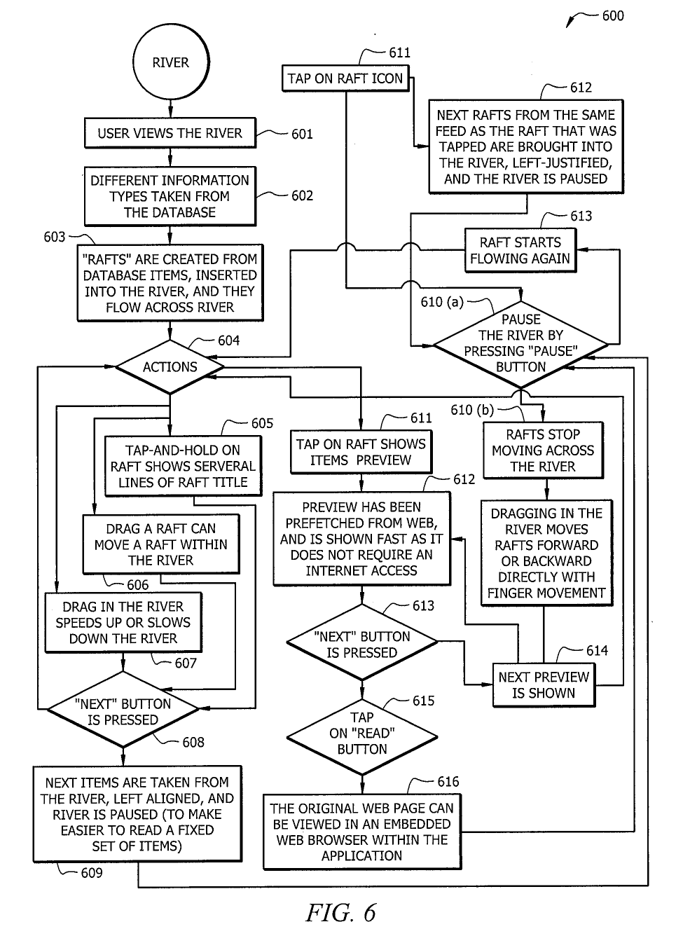

Method 600 of FIG. 6 shows one example of logic for discovering and reading information in the river interface. Some of the actions shown in FIG. 6 are performed by a user, some are performed by the hand-held device, and others are performed by a server (such as server 301 of FIG. 3). Method 600 assumes that a user currently has the river application on a device. Method 600 also assumes a touch screen; however, method 600 can be adapted for use in a device without a touch screen, e.g., by matching keys on a keypad to actions to one or more commands. In action 601, the user views the river.

In action 602, the interface application (executed by a processor of the device) accesses the content in the database. In action 603, the application creates items for the river using the accessed information. For some river embodiments, an information item that appears to “float” across the screen is called a “raft.”

In action 604, the user can begin to interact with the river and with the information therein. Actions 605-607 are user interactions that include tapping, holding, and/or dragging.

In action 608, a “next” option is selected when no particular raft is selected. Action 608 advances the river and pauses it, as shown in item 609. The river can also be paused and unpaused (action 613) with a pause option, as in action 610. When the river is paused and a raft is selected, as in action 611, the feed is advanced so that the next rafts are shown, as in action 612. When the river is paused, a dragging motion will cause the river to move with the dragging motion in action 617.

In action 611, a raft is selected, e.g., by tapping, to show a preview. In this example, a preview of the information has been prefetched and stored in the database and is displayed on the interface. When the user selects “next,” a preview for the next item in the flow is shown.

When the user selects “read,” the information content is displayed, as in action 615. In one example, the raft represents a web page. During the reading action, the web page is opened using a web browser in action 616. Any kind of information item can be opened, such as an SMS or MMS message, a picture, and the like.

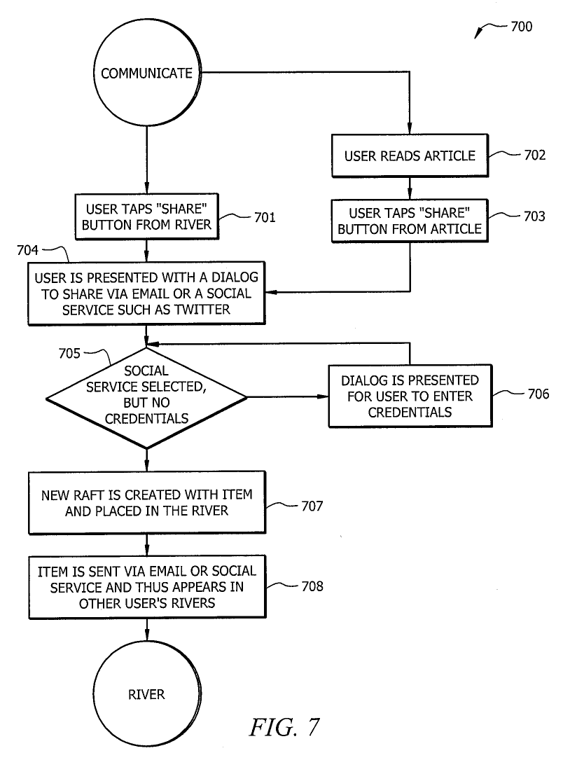

Method 700 of FIG. 7 is one example of logic for communicating with others, generally, as well as for communicating about the river. Some of the actions shown in FIG. 7 are performed by a user, some are performed by the hand-held device, and others are performed by a server (such as server 301 of FIG. 3).

In action 701, a user selects a “share” option from the interface in order to craft a message. In actions 702 and 703, a user is viewing an article and selects a share option associated with the article. While actions 702 and 703 are directed to articles, any other type of information item can be viewed and shared as well.

In action 704, the user is presented with a dialog presenting various sharing options, such as by email, SMS, MMS, or social service. If the user selects to send the information item other than by social service, then the user is presented the dialogs and interfaces to do so. If the user chooses to send the information item via a social service, then the social service is called and used to send the item in actions 705 and 706. Whether by email, social service, or otherwise, a new raft is created from the information item and placed in the river in action 707. In action 708, the item is sent to the other users via the river's social streams in each of the users' interfaces.

FIGS. 4-7 show example techniques for use of an interface, such that interface 100 of FIGS. 1A-C. However, the scope of embodiments is not so limited. For example, the specific ways that users interact with the interface (e.g., by tapping or dragging on a touchscreen) can be changed for embodiments that use other input/output devices (such as keypads) without straying from the scope of embodiments. Additionally, the techniques of FIGS. 4-7 can be adapted for use in embodiments that employ a single, combined information flow. Furthermore, the specific order of the actions in the techniques of FIGS. 4-7 is exemplary and provided for illustrative purposes. Some embodiments may add, omit, delete, or rearrange actions.

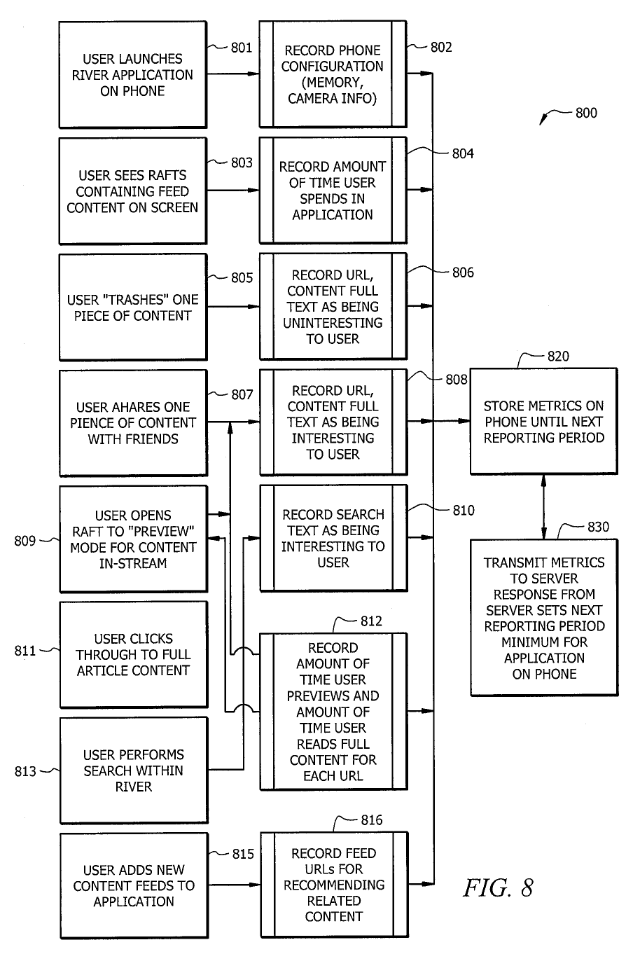

FIGS. 8-10 are illustrations of exemplary methods of interaction between devices, applications, users, and content servers, according to various embodiments of the invention. For instance, FIG. 8 is an illustration of exemplary method 800, showing relationships between user actions and recorded metrics. Each of actions labeled “User Actions” leads to one or more “Metrics Recorded.” Each of the Metrics Recorded are stored on the user device until a next recording period, as shown in action 820. In action 830, metrics sorted on the user device are transmitted to a server, and a response from the server to the user device sets the next reporting period minimum for the interface application on the user device. The server referred to in FIG. 8 is, e.g., a server for an entity that provides and/or services the interface application described in the figures above (such as server 301 of FIG. 3). The server can use the transmitted information for a variety of purposes, such as recommending related content to a user, providing user interests information to content sponsors, refining the user experience, and the like.

In action 801, the user launches the interface application (e.g., the river interface) on a phone or other user device. In action 802, the user device records one or more of its configuration metrics.

In action 803, the user uses the interface, whether simply by allowing the application to run or by actively interacting with the interface. In action 804, the user device records the amount of time that the user spends running the interface application.

In action 805, the user trashes (e.g., deletes) a piece of content from the interface. In action 806, the user device marks information about the content (e.g., its URL, its full text) as being uninteresting to the user.

In action 807, the user shares a piece of content with friends by, e.g., placing it in a social flow. In action 808, the user device marks the piece of content as interesting to the user.

In action 809, the user opens a raft in the river to a preview mode. In action 808, the user device marks the piece of content as interesting to the user. Further, in action 812, the user device records the amount of time the user previews the content.

In action 811, the user accesses the full content of a piece of content. In action 808, the user device marks the piece of content as interesting to the user. In action 812, the user device records the amount of time the user reads the content.

In action 813, the user performs a search within the interface. In action 810, the user device records the search text as interesting to the user.

In action 815, the user adds new content feeds to the application by, e.g., adding a new feed to a personal information flow. In action 816, the user device records the URLs of the feeds for recommending related content.

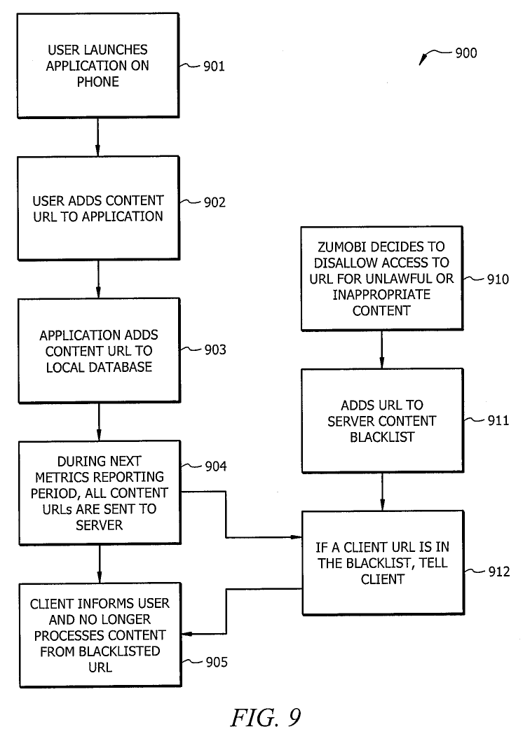

FIG. 9 is an illustration of exemplary method 900 showing interaction between user, application, and server when a user adds content to the interface. In action 901, a user launches the interface application in a phone or other user device. In action 902, the user adds a content URL to the interface by, e.g., adding it to a personal information flow. The user can then view and share the content.

In action 903, the interface application adds the content URL to the local database. In step 904, the URLs from the database are sent to the server (such as server 301 of FIG. 3) in a metric reporting period.

In action 910, the provider of the interface application (i.e., the operator of the server program) decides to disallow access to a particular URL for unlawful or inappropriate content. In action 911, the provider of the interface application adds the particular URL to a blacklist database. Actions 910 and 911 may occur before, during, or after actions 901-904. In action 912, the server checks the user's added URL against the blacklist. If the user's added URL appears in the blacklist, a message is sent to the interface application indicating that the user's added URL is blacklisted. If the user's added URL is blacklisted, then in action 905 the application interface informs the user and does not process content from the URL. Subsequent access attempts to the blacklisted URL will also go unserviced.

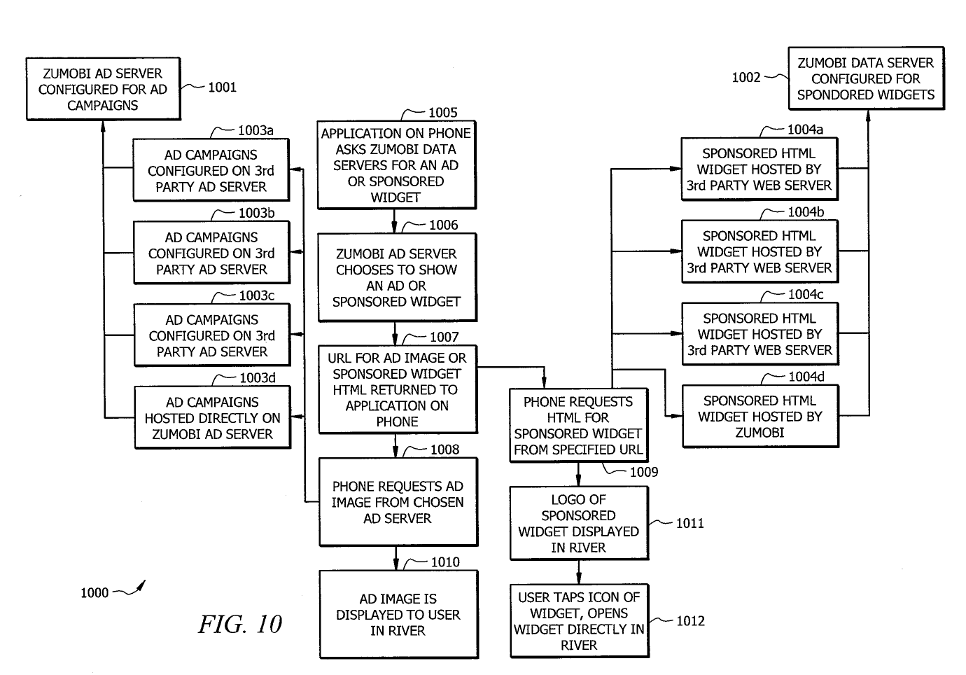

FIG. 10 is an illustration of exemplary method 1000 showing interaction among a user, an interface application, a user device, one or more servers providing and/or servicing the interface application (such as server 301 of FIG. 3, also referred to as “Zumobi” servers in FIG. 10), and third party content servers (such as server 304 of FIG. 3). As shown in actions 1001 and 1002, the servers providing and/or servicing the interface application are configured for advertisement campaigns as well as for sponsored widgets.

Action 1003 illustrates that the advertising campaigns are configured on third party servers. Action 1004 illustrates that HTML widgets are hosted on third party web servers. Actions 1003 and 1004 are repeated in order to show that the servers providing and/or servicing the interface application can receive content from a variety of separate and different sponsors. The numbers of sponsors of advertising campaigns and HTML widgets is not limited to four and can be as large or as small as set by the servers providing and/or servicing the interface application, the interface applications, and/or user preferences.

In action 1005, an interface application on a phone or other user device asks one or more Zumobi servers for an advertisement or sponsored widget. In action 1006, the one or more Zumobi servers check if there is appropriate content available for the requesting device, and if so, sends a URL for an advertising image and/or a sponsored widget to the requesting device in action 1007. Using the received URL, the device can request content from one or more third party servers in actions 1008 and 1009. In actions 1010 and 1011, the requested content is delivered to the device and displayed on the user interface. In the case of a widget, user selection, such as by a tap, opens the widget directly in an information flow of the user interface in action 1012.

FIGS. 8-10 show example interactions among the participants in the information exchanges of a variety of embodiments. However, the scope of embodiments is not limited to that shown in the FIGURES. For example, the specific order of the actions in the flows of FIGS. 8-10 is exemplary and provided for illustrative purposes. Some embodiments may add, omit, delete, or rearrange actions. Moreover, embodiments can be adapted for use with any of a variety of communication protocols and networks.

Embodiments of the invention provide one or more advantages over prior art techniques. Various embodiments provide a new way of presenting content to users and letting users discover, share, and access information using existing feed technology, existing filtering technology, and existing recommendation technology. One of the problems with current mechanisms for content discovery is that sharing and access are not good enough on mobile devices due to the limitations of screen space and control. Various embodiments make more effective use of screen space by making content flow in a virtual river. Further, various embodiments provide a way to reduce the amount of interaction that is needed from a user to access information, thereby effectively adding functionality to otherwise limited mobile devices. Further, some embodiments provide a way to integrate personal, social and public interests and information. The end result is a better user experience for accessing information and the mechanisms to get there are specific structural user-interface elements.

When implemented via computer-executable instructions, various elements of embodiments of the present invention are in essence the software code defining the operations of such various elements. The executable instructions or software code may be obtained from a tangible computer-readable medium (e.g., a hard drive media, optical media, EPROM, EEPROM, tape media, cartridge media, flash memory, ROM, memory stick, and/or the like). In fact, computer-readable media can include any medium that can store information.

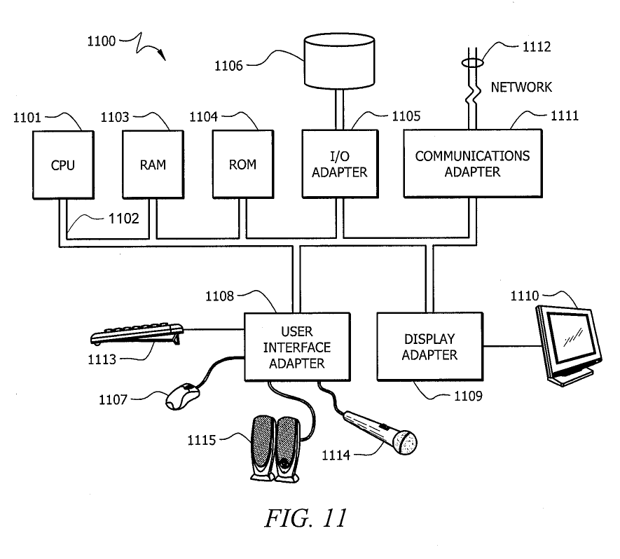

FIG. 11 illustrates an example computer system 1100 adapted according to one embodiment of the present invention. That is, computer system 1100 comprises an example system on which embodiments of the present invention may be implemented (such as a server that delivers content to devices or a processor based device, such as device 101 of FIGS. 1A-D, that provides a user interface according to embodiments of the invention). Central processing unit (CPU) 1101 is coupled to system bus 1102. CPU 1101 may be any general purpose CPU. The present invention is not restricted by the architecture of CPU 1101 as long as CPU 1101 supports the inventive operations as described herein. CPU 1101 may execute the various logical instructions according to embodiments of the present invention. For example, CPU 1101 may execute machine-level instructions according to the exemplary operational flows described above in conjunction with FIGS. 4-10 and may execute code to perform processes shown as functional units in any of the FIGS. 3-10.

Computer system 1100 also preferably includes random access memory (RAM) 1103, which may be SRAM, DRAM, SDRAM, or the like. Computer system 1100 preferably includes read-only memory (ROM) 1104 which may be PROM, EPROM, EEPROM, or the like. RAM 1103 and ROM 1104 hold user and system data and programs, as is well known in the art.

Computer system 1100 also preferably includes input/output (I/O) adapter 1105, communications adapter 1111, user interface adapter 1108, and display adapter 1109. I/O adapter 1105, user interface adapter 1108, and/or communications adapter 1111 may, in certain embodiments, enable a user to interact with computer system 1100 in order to input information, such as allowing a user to select an item of information, create an item of information, place an item of information into the river, and/or the like.

I/O adapter 1105 preferably connects to storage device(s) 1106, such as one or more of hard drive, compact disc (CD) drive, floppy disk drive, tape drive, etc. to computer system 1100. The storage devices may be utilized when RAM 1103 is insufficient for the memory requirements associated with storing data. Communications adapter 1111 is preferably adapted to couple computer system 1100 to network 1112 (e.g., a local area network, the Internet, and/or the like). User interface adapter 1108 couples user input devices, such as keyboard 1113, pointing device 1107, and microphone 1114 and/or output devices, such as speaker(s) 1115 to computer system 1100. Display adapter 1109 is driven by CPU 1101 to control the display on display device 1110 to, for example, display the user interface of FIG. 1A, which may include touchscreen capability.

It shall be appreciated that the present invention is not limited to the architecture of system 1100. For example, any suitable processor-based device may be utilized, including without limitation personal computers, laptop computers, handheld computing devices, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A user interface for use in one or more processor-based devices, said user interface comprising:
an interactive, social ticker shared among a plurality of users, said interactive social ticker including an animated flow of selectable content.

2. The user interface of claim 1 wherein said animated flow of selectable content comprises;
a first interactive flow; and
a second interactive flow, wherein said selectable content includes items moveable among said first and second interactive flows.

3. The user interface of claim 2 wherein said first interactive flow comprises general interest content, and wherein said second interactive flow includes socially filtered content shared among said plurality of users.

4. The user interface of claim 3 further comprising:
a third interactive flow including items filtered based at least in part on user preferences.

5. The user interface of claim 1, wherein said user interface is displayed upon a screen of a handheld device.

6. The user interface of claim 1, wherein said user interface is displayed upon a screen of a desktop device.

7. The user interface of claim 1, wherein said animated flow simulates water movement, and wherein said selectable content comprises items rendered to simulate floating on said water.

8. The user interface of claim 7 further comprising a beach area adjacent said water, said beach area including one or more selectable buttons.

9. The user interface of claim 1 wherein said user interface is displayed upon a screen of said processor-based device, and wherein control is provided by a directional input control adjacent to a display area.

10. The user interface of claim 1 wherein items of said selectable content are moved within a display space of said user interface using a drag and drop action.

11. The user interface of claim 1 wherein said interactive social ticker comprises an information flow that includes public content and content shared within a social group.

12. The user interface of claim 11 wherein said social ticker further comprises content provided based on personal interest information about a user.

13. The user interface of claim 1 wherein said selectable content is selected from the list consisting of:
widgets;
tiles;
icons;
text;
pictures; and
videos.

14. A user interface for use in one or more processor-based devices, said user interface comprising:
a social ticker that receives items of content, integrates the items of content into an animated flow, and shares the items of content among a plurality of animated flows on a plurality of devices.

15. The user interface of claim 14, wherein said user interface is displayed upon a screen of a handheld device.

16. The user interface of claim 14, wherein said social ticker further comprises a public information flow including items of general interest content.

17. The user interface of claim 14, wherein said social ticker further comprises a personal information flow including items filtered for personal interest.

18. The user interface of claim 14, wherein at least one of said items of content includes a preview mode wherein selection of said at least one item results in a truncated view of underlying content of said at least one item.

19. The user interface of claim 14, further comprising:
a dialog box for creating content and inserting said created content into said animated flow.

20. The user interface of claim 14, wherein said user interface is in communication with a database which provides said items of content to said user interface.

21. The user interface of claim 14, wherein said user interface is included in an application that is in communication with a web server for providing said items of content.

22. The user interface of claim 14 wherein said interactive social ticker comprises an information flow that includes public content and content shared within a social group.

23. The user interface of claim 14 wherein said social ticker further comprises content provided based on personal interest information about a user.

24. A user interface for use in one or more processor-based devices, said user interface comprising:
an animated flow of information items across a screen of a device, said animated flow providing for selection of said items, wherein selection of one of said items causes said item to expand and present information content within said screen.

25. The user interface of claim 24 wherein said items of information items in said flow are selected from the list consisting of:
widgets;
tiles;
icons;
text;
pictures; and
videos.

26. The user interface of claim 24, wherein said user interface is displayed upon a screen of a handheld device.

27. The user interface of claim 24, wherein said animated flow comprises:
a first interactive flow; and
a second interactive flow, wherein said information items are moveable among said first and second interactive flows.

28. The user interface of claim 27 wherein said first interactive flow comprises general interest content, and wherein said second interactive flow includes socially filtered content shared among a plurality of users.

29. The user interface of claim 24 wherein said animated flow comprises an interactive social flow shared among a plurality of users, wherein said users of said plurality of users create content in said interactive social flow.

30. The user interface of claim 24 wherein said animated flow includes public content and content shared within a social group.

31. The user interface of claim 24 wherein said animated flow further comprises content provided based on personal interest information about a user.

32. A method for operating a processor-based server computer, said method comprising:
receiving a communication from a first processor-based device, said communication providing an information item and indicating that said information item is to be placed in an interactive social ticker;
receiving a communication from a second processor-based device; and
in response to said communication from said second processor-based device, sending said informational item to said second processor-based device with an indication that said informational item is to be placed in an interactive social ticker on a screen of said second processor-based device.

33. The method of claim 32 wherein said communication from said second processor-based device comprises polling.

34. The method of claim 32 further comprising:
receiving information from said first processor-based device indicating one or more user preferences.

35. The method of claim 32, wherein said information item received from said first processor-based device comprises a Uniform Resource Locator (URL), said method further comprising:
comparing said URL against a blacklist database.

36. The method of claim 32 wherein said processor-based server computer sets communication intervals for said first processor-based device.

37. The method of claim 32 further comprising:
receiving from said first processor-based device a request for an advertisement sponsored by a third party.

38. The method of claim 37 further comprising:
receiving said advertisement from said third party; and
providing said advertisement to said first processor-based device in response to said request.

39. A computer program product having a computer readable medium having computer program logic recorded thereon for providing a user interface, said computer program product comprising:
code for rendering a social ticker on said user interface;
code for receiving items of content using said user interface;
code for integrating the items of content into an animated flow on said social ticker; and
code for sharing the items of content among a plurality of animated flows on a plurality of devices.
